(19) United States
(12) Patent Application Publication
(10) Pub. No.: US 2026/0201210 A1
(43) Pub. Date: Jul. 16, 2026

(54) SILICONE COATINGS

(71) Applicant: DOW SILICONES CORPORATION, Midland, MI (US)

(72) Inventors: Rui WANG, Shanghai (CN); Yusheng CHEN, Shanghai (CN); Yi GUO, Shanghai (CN)

(21) Appl. No.: 19/136,426

(22) PCT Filed: Dec. 9, 2022
(86) PCT No.: PCT/CN2022/138091

§ 371 Date: Jun. 6, 2025

(51) Int. Cl. C09D 183/06; C08G 77/00; C08G 77/12; C08G 77/16; C08G 77/18; C08G 77/20; C08K 3/26; C08K 9/04; C09D 7/61; C09D 7/62; D06M 15/643; D06M 101/34; D06N 3/00; D06N 3/12

(52) U.S. Cl. CPC C09D 183/06; C08G 77/12; C08G 77/16; C08G 77/18; C08G 77/20; C09D 7/61; C09D 7/62; D06M 15/643; D06N 3/0034; D06N 3/0059; D06N 3/0063; D06N 3/0077; D06N 3/128; C08G 77/70; C08K 2003/267; C08K 9/04; D06M 2101/34; D06M 2200/30; D06N 2209/067; D06N 2211/00

(57) ABSTRACT

This disclosure relates to a hydrosilylation curable silicone coating composition comprising (b) a filler blend of hydromagnesite and huntite, a method of coating textile materials and/or airbags with the composition, and textile materials and airbags coated with the cured product of the composition. The composition comprises: (a) an organopolysiloxane polymer having a viscosity of between 100 and 200,000 mPa·s at 25° C., and at least two unsaturated groups per molecule; (b) the filler blend, which may be treated with a hydrophobing agent; (c) an organosilicon compound having at least two Si—H groups per molecule; (d) a hydrosilylation cure catalyst; (e) one or more silicone resins containing unsaturated groups selected from alkenyl groups, alkynyl groups, or a mixture of alkenyl groups and alkynyl groups; and (f) an adhesion promoter.

This disclosure relates to a hydrosilylation curable silicone coating composition, a method of coating textile materials and/or airbags with said hydrosilylation curable silicone coating composition and textile materials and airbags coated with the cured product of the hydrosilylation curable silicone coating composition.

Such hydrosilylation curable silicone coating compositions can be used in screen printing, as a base coating for silicone leather, as a binder layer coating between a textile and a silicone coating and especially for coating airbags and textile materials used in or for airbags.

An airbag arrangement in a vehicle generally consists of one or more inflatable textile bag(s) (sometimes referred to as cushions), a sensor and a means of inflation.

Airbags and/or textile materials used in the making of airbags may be made from a woven or knitted fabric of synthetic fibres, for example polyamides such as nylon-6,6, or polyesters such as polyethylene terephthalate. The airbags may be made from flat textile material pieces which are coated and then sewn together to provide sufficient mechanical strength (generally referred to as “cut-and-sewn, seam-sealed (CSSS) airbags”) or may be woven in one-piece (generally referred to as “one-piece woven (OPW) airbags”) with integrally woven seams. Sewn flat textile material airbags are generally assembled with the coated textile material surface on the inside of the airbag. One-piece woven airbags are coated on the outside of the airbag and are better able to retain gas pressure after deployment and therefore tend to be used for airbags designed to remain inflated for longer periods of time after a collision or the like, e.g., side-curtain airbags.

A variety of airbags are utilized as inflatable safety restraint devices, designed to expand and deploy in collision situations, most notably in vehicles. Today, it is generally compulsory to have several airbags in vehicles as a means of providing safety to the occupants in the event of a collision. They include frontal airbags, front-centre airbags, side airbags, side-curtain airbags thorax airbags, and/or knee airbags.

Typically, frontal airbags and/or front-centre airbags, and their inflation mechanisms are concealed within the vehicle trim to be invisible during normal vehicle operation. For example, frontal airbags may be installed in the steering wheel boss on the driver's side of a car and in the dashboard on the passenger side of a car behind plastic flaps or doors which are designed to tear open under the force of the bag inflating. They are provided to function as a cushion at a point of impact especially in collisions with the front or back of the vehicle. Once a predetermined threshold has been reached or exceeded, the airbag control unit triggers ignition of a gas generator propellant to rapidly inflate the airbag. As the vehicle occupant collides with and squeezes the bag, the gas is designed to escape the bag in a controlled manner and as such these airbags are required to exhibit relatively high air permeabilities to allow the expanded airbag to quickly deflate after the initial impact. Typically, these airbags are of a cut-and-sewn, seam-sealed (CSSS) airbag design although they may also be of a one-piece woven design, if preferred or the situation dictates.

Side-curtain airbags are increasingly utilized and are usually mounted within the headliner above the doors and windows and deploy along the side window from the vicinity of the ceiling to protect vehicle occupants from a side collision and consequent rollover incidents (where the vehicle tips over onto its side or upside-down or flips over more than once). Side-curtain airbags, however, have been designed primarily to protect passengers during rollover crashes by retaining their inflated state for a long duration (for example, exhibiting a retention of at least 50% of the initial pressure after 5 seconds subsequent to high pressure inflation) and generally unroll from packing containers stored within the roofline along the side windows of an automobile (and thus have a back and front side only). Side-curtain airbags therefore are designed to not only provide cushioning effects but also provide protection from broken glass and other debris. As such, it is imperative, as noted above, that side-curtain airbags, remain inflated for several seconds until the end of the rollover period resulting from a collision, i.e., they need to retain large amounts of gas, as well as high gas pressures, throughout the longer time periods of the entire potential rollover.

Silicone rubber coatings are often provided on textile materials and airbags and are designed to keep airbags flexible and resistant to temperature fluctuations, aging and abrasion. They need such properties because, for example, an airbag may remain unused for an extended period of time (e.g., several years) before a collision triggers deployment. This necessitates such silicone rubber coatings to be very stable over time in order to prevent the airbag from becoming stuck and to ensure smooth deployment even after many years. Such silicone rubber coatings need to provide good thermal stability given the inflator is usually designed to release extremely hot gases during inflation which could otherwise cause burns to an occupant and they are provided to prevent, or at least significantly reduce, the likelihood of the textile material onto which the coating is applied from burning through to the occupant. Furthermore, whilst traditionally utilized silicone airbag coatings provide excellent durability, aging, and processability benefits, they also tend to display very low tensile strength and elongation at break characteristics that do not withstand high pressure inflation easily without the utilization of very thick coatings.

It has been found in the case of front and rear impact airbags, especially for CSSS airbags, as the means for inflating such airbags have developed, apparatus such as gas generators have become increasingly mechanically and thermally aggressive causing additional problems regarding the stitching of such airbags in addition to the physical constraints associated with the deployment of the inflatable bag. This can result in the ripping of the silicone elastomer coated textile material and opening of the stitches giving rise to tearing, combing (fraying) and even bursting of certain airbags. Consequently, airbag manufacturers are in search of silicone elastomeric coating compositions for applications that have optimum mechanical properties, especially good tear strength and edgecomb resistance (ability of the coated textile material to withstand combing/fraying of the stitches of the inflatable bag). However, coatings resulting from the cure of such compositions tend to have good edgecomb resistance or good tear strength. Obtaining a good compromise between these two properties, while maintaining good adhesive properties is proving to be a problem across the industry.

The silicone airbag coating compositions used tend to be hydrosilylation (addition) cure compositions which cure by the cross-linking of organopolysiloxane polymers having at least two Si-vinyl groups with cross-linkers containing at least two, typically at least three Si—H bonds per molecule. Such coating compositions are utilised for treating airbag fabrics e.g., on the inner side of CSSS type airbags and outer of OPW type airbags and often include the presence of silicone resins especially those referred to as MQ resins to enable good flowability and high modulus as well as flame resistance, not least because they exhibit very good solubility in the vinyl organopolysiloxanes utilised. Typically, such compositions are considered to additionally require reinforcing fillers such as precipitated silica and/or fumed silica in order for the resulting coated airbag to achieve good edgecomb resistance. However, the incorporation of such reinforcing fillers causes significant thickening to the silicone airbag coating compositions, leading to high viscosity and shear thinning effects (the non-Newtonian behavior of fluids whose viscosity decreases under shear strain), if significant amounts of reinforcing silica fillers are utilised. This necessitates a low-level loading of the silica (e.g., less than or equal to 10 wt. % of the composition) in order to maintain flowability. Typically, therefore, calcium carbonate (CaCO₃) is used as an additional filler as it does not have the same shear thinning effect enabling said silicone airbag coating compositions to retain a composition with good flowability at higher filler loading levels.

However, alternative solutions are still being sought to achieve airbag coatings with all the different required properties.

There is provided herein, a hydrosilylation curable silicone coating composition comprising:
a) an organopolysiloxane polymer having a viscosity of between 100 and 200,000 mPa·s at 25° C., and at least two unsaturated groups per molecule, which unsaturated groups are selected from alkenyl or alkynyl groups;
b) a filler blend of hydromagnesite, which has the structure Mg₅(CO₃)₄(OH)₂·4H₂O and huntite which has the structure Mg₃Ca(CO₃)₄, which filler blend may be treated with a suitable hydrophobing agent;
c) an organosilicon compound having at least two, or three Si—H groups per molecule;
d) a hydrosilylation cure catalyst;
e) one or more silicone resins containing unsaturated groups selected from alkenyl groups, alkynyl groups or a mixture of alkenyl groups and alkynyl groups, selected from T silicone resins (silsesquioxanes), DT silicone resins, MQ silicone resins, MDT silicone resins, MTQ silicone resins, QDT silicone resins or mixtures thereof;
f) an adhesion promoter selected from one or more monoacrylates, diacrylates or methacrylates; epoxy-containing alkoxysilanes, vinyl-containing alkoxysilanes, alkoxysilanes containing methacrylic groups or alkoxysilanes containing acrylic groups and a mixture and/or reaction product of
   i) one or more alkoxysilanes having an epoxy group in the molecule;
   ii) a linear organopolysiloxane oligomer containing at least one alkenyl group and at least one hydroxy or alkoxy group per molecule; and
   iii) an organometallic condensation reaction catalyst comprising organotitanium, organoaluminum or organozirconium compounds; or a mixture thereof.

There is also provided herein a textile material or airbag at least partially coated with a silicone coating which is the cured elastomeric product of the hydrosilylation curable silicone coating composition described above.

There is also provided a method of coating a textile material or airbag by mixing the components of a hydrosilylation curable silicone coating composition comprising:
a hydrosilylation curable silicone coating composition comprising:
a) an organopolysiloxane polymer having a viscosity of between 100 and 200,000 mPa·s at 25° C., and at least two unsaturated groups per molecule, which unsaturated groups are selected from alkenyl or alkynyl groups;
b) a filler blend of hydromagnesite, which has the structure Mg₅(CO₃)₄(OH)₂·4H₂O and huntite which has the structure Mg₃Ca(CO₃)₄, which filler blend may be treated with a suitable hydrophobing agent;
c) an organosilicon compound having at least two, three Si—H groups per molecule;
d) a hydrosilylation cure catalyst;
e) one or more silicone resins containing unsaturated groups selected from alkenyl groups, alkynyl groups or a mixture of alkenyl groups and alkynyl groups, selected from T silicone resins (silsesquioxanes), DT silicone resins, MQ silicone resins, MDT silicone resins, MTQ silicone resins, QDT silicone resins or mixtures thereof;
f) an adhesion promoter selected from one or more monoacrylates, diacrylates or methacrylates; epoxy-containing alkoxysilanes, vinyl-containing alkoxysilanes, alkoxysilanes containing methacrylic groups or alkoxysilanes containing acrylic groups and a mixture and/or reaction product of
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst comprising organotitanium, organoaluminum or organozirconium compounds; or a mixture thereof; and
   coating the textile material or airbag with the composition and curing said composition.

There is also provided a coated textile material or coated airbag obtained or obtainable by coating a textile material or airbag by mixing the components of a hydrosilylation curable silicone coating composition comprising:
a hydrosilylation curable silicone coating composition comprising:
a) an organopolysiloxane polymer having a viscosity of between 100 and 200,000 mPa·s at 25° C., and at least two unsaturated groups per molecule, which unsaturated groups are selected from alkenyl or alkynyl groups;
b) a filler blend of hydromagnesite, which has the structure Mg₅(CO₃)₄(OH)₂·4H₂O and huntite which has the structure Mg₃Ca(CO₃)₄, which filler blend may be treated with a suitable hydrophobing agent;
c) an organosilicon compound having at least two, or three Si—H groups per molecule;
d) a hydrosilylation cure catalyst;
e) one or more silicone resins containing unsaturated groups selected from alkenyl groups, alkynyl groups or a mixture of alkenyl groups and alkynyl groups, selected from T silicone resins (silsesquioxanes), DT silicone resins, MQ silicone resins, MDT silicone resins, MTQ silicone resins, QDT silicone resins or mixtures thereof;
f) an adhesion promoter selected from one or more monoacrylates, diacrylates or methacrylates; epoxy-containing alkoxysilanes, vinyl-containing alkoxysilanes, alkoxysilanes containing methacrylic groups or alkoxysilanes containing acrylic groups and a mixture and/or reaction product of
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst comprising organotitanium, organoaluminum or organozirconium compounds; or a mixture thereof; and
   coating the textile material or airbag with the composition and curing said composition.

It was found that the combination of components (b) and (e) surprisingly provides the coating composition with good flowability without a shear thinning effect, and post cure gives improved edgecomb resistance, maintained adhesion and mechanical strength which is notable and surprising given such results are achieved in the absence of fumed silica and precipitated silica and preferably also in the absence of calcium carbonate.

Whilst the hydrosilylation curable silicone coating compositions herein can be used in screen printing, as a base coating for silicone leather, as a binder layer coating between a textile and a silicone coating, this disclosure is directed to textile material used to make cut-and-sewn, seam-sealed (CSSS) airbags or one-piece woven airbags design and airbags of both types especially those used to cushion occupants after a frontal or rear collision rather than for side airbags which tend to require comparatively longer inflation periods. Such coating compositions are applied onto textile material surfaces which are designed to be on the inside of the CSSS type airbags and for coatings on the outside of one-piece woven airbags, in each case designed for cushioning frontal and rear collisions. They are not designed for use as coatings for curtain or side type airbags requiring extended periods of inflation. The hydrosilylation curable silicone coating compositions herein are designed to be coated directly onto the material/airbag and would not generally be used as a topcoat on top of intermediate coatings applied directly onto the fabric/airbag. Furthermore, such coatings as described herein would not require a topcoat applied thereto in order to function.

The hydrosilylation curable silicone coating composition utilized to make the coating comprises the following components:

### (a) Organopolysiloxane Polymers

Component (a) of the hydrosilylation curable silicone coating composition is one or more organopolysiloxane polymers having a viscosity of between 100 and 200,000 mPa·s at 25° C., and at least two unsaturated groups per molecule, which unsaturated groups are selected from alkenyl or alkynyl groups. Each organopolysiloxane polymer of component (a) comprises multiple siloxy units, of formula (I):

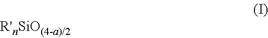

The subscript “a” is 0, 1, 2 or 3.

Siloxy units may be described by a shorthand (abbreviated) nomenclature, namely—“M,” “D,” “T,” and “Q”, when R′ is usually an aliphatic hydrocarbyl group, a substituted aliphatic hydrocarbyl group, an aromatic group or a substituted aromatic group and is further described below, alternatively an alkyl group, typically a methyl group. The M unit corresponds to a siloxy unit where a=3, that is R′₃SiO_{1/2}; the D unit corresponds to a siloxy unit where a=2, namely R′₂SiO_{2/2}; the T unit corresponds to a siloxy unit where a=1, namely R′₁SiO_{3/2}, the Q unit corresponds to a siloxy unit where a=0, namely SiO_{4/2}. The organopolysiloxane polymer of component (a) is substantially linear but may contain a proportion of branching due to the presence of T units (as previously described) within the molecule, hence the average value of a in structure (I) is about 2.

The unsaturated groups of component (a) may be positioned either terminally or pendently on the organopolysiloxane polymer, or in both locations. The unsaturated groups of component (a) may be alkenyl groups or alkynyl groups as described above. Each alkenyl group, when present, may comprise for example from 2 to 30, alternatively 2 to 24, alternatively 2 to 20, alternatively 2 to 12, alternatively 2 to 10, and alternatively 2 to 6 carbon atoms. When present the alkenyl groups may be exemplified by, but not limited to, vinyl, allyl, methallyl, propenyl, and hexenyl and cyclohexenyl groups. Each alkynyl group, when present, may also have 2 to 30, alternatively 2 to 24, alternatively 2 to 20, alternatively 2 to 12, alternatively 2 to 10, and alternatively 2 to 6 carbon atoms. Examples of alkynyl groups may be exemplified by, but not limited to, ethynyl, propynyl, and butynyl groups. Preferred examples of the unsaturated groups of component (a) include vinyl, propenyl, isopropenyl, butenyl, allyl, and 5-hexenyl.

In formula (I), each R′, other than the unsaturated groups described above, is independently selected from an aliphatic hydrocarbyl group, a substituted aliphatic hydrocarbyl group, an aromatic group or a substituted aromatic group. Each aliphatic hydrocarbyl group may be exemplified by, but not limited to, alkyl groups having from 1 to 20 carbons per group, alternatively 1 to 15 carbons per group, alternatively 1 to 12 carbons per group, alternatively 1 to 10 carbons per group, alternatively 1 to 6 carbons per group or cycloalkyl groups such as cyclohexyl. Specific examples of alkyl groups may include methyl, ethyl, propyl, pentyl, octyl, undecyl, and octadecyl groups, alternatively methyl and ethyl groups. Substituted aliphatic hydrocarbyl group are preferably non-halogenated substituted alkyl groups.

The aliphatic non-halogenated organyl groups are exemplified by, but not limited to alkyl groups as described above with a substituted group such as suitable nitrogen containing groups such as amido groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. Examples of aromatic groups or substituted aromatic groups are phenyl groups and substituted phenyl groups with substituted groups as described above.

Component (a) may, for example, be selected from polydimethylsiloxanes, alkylmethylpolysiloxanes, alkylarylpolysiloxanes or copolymers thereof (where reference to alkyl means any suitable alkyl group, alternatively an alkyl group having two or more carbons) providing each polymer has a viscosity of organopolysiloxane polymer (a) should be between 100 and 200,000 mPa·s at 25° C.,

Hence component (a) may, for the sake of example, be:
a dialkylalkenyl terminated polydimethylsiloxane, e.g., dimethylvinyl terminated polydimethylsiloxane; a dialkylalkenyl terminated dimethylmethylphenylsiloxane, e.g., dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxane; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane.

In each case component (a) The viscosity of organopolysiloxane polymer (a) should be between 100 and 200,000 mPa·s at 25° C., alternatively between 1000 and 150,000 mPa·s at 25° C., alternatively, from 1000 mPa·s to 125,000 mPa·s, alternatively from 1000 mPa·s to 100,000 mPa·s at 25° C. Unless otherwise indicated all viscosity measurement given are measured in accordance with ASTM D 1084 Method B using a Brookfield DV III rotational viscometer with the most appropriate spindle CP-52 for the viscosity being measured at 1 rpm. Typically, the alkenyl and/or alkynyl content, e.g., vinyl content of the polymer is from 0.01 to 3 wt. % for each organopolysiloxane polymer containing at least two silicon-bonded alkenyl groups per molecule of component (a), alternatively from 0.01 to 2.5 wt. % of component (a), alternatively from 0.001 to 2.0 wt. %, alternatively from 0.01 to 1.5 wt. % of component (a) of the or each organopolysiloxane polymer containing at least two unsaturated groups per molecule, which unsaturated groups are selected from alkenyl or alkynyl groups per molecule of component (a). The alkenyl/alkynyl content of component (a) is determined using quantitative infra-red analysis in accordance with ASTM E168.

Component (a) may be present in the composition in an amount of from 40 wt. % to about 80 wt. % of the composition, alternatively from 45 to 80 wt. % of the composition, alternatively from 50 to 80 wt. % of the composition. Typically, component (a) is present in an amount which is the difference between 100 wt. % and the cumulative wt. % of the other components/ingredients of the composition.

### Component (b) Filler Blend of Hydromagnesite and Huntite (HMH)

Component (b) of the hydrosilylation curable silicone coating composition is a filler blend of hydromagnesite, which has the structure Mg₅(CO₃)₄(OH)₂·4H₂O and huntite which has the structure Mg₃Ca(CO₃)₄, which filler blend may be treated with a suitable hydrophobing agent. Hydromagnesite, is a hydrated magnesium carbonate mineral sometimes referred to as light magnesium carbonate.

Typically, both hydromagnesite, and huntite are naturally hydrophilic and therefore may be treated with a hydrophobing treating agent to render them hydrophobic. These surface modified filler blend (b) do not clump and can be homogeneously incorporated into organopolysiloxane polymer (a), as the surface treatment makes the fillers easily wetted by organopolysiloxane polymer (a). Blends of hydromagnesite, and huntite are commercially available e.g., under the tradenames UltraCarb™ 1251, UltraCarb™ 1253, and UltraCarb™ LH3C from LKAB Minerals AB of Lulea, Sweden. Such filler blends comprise particles having particles sizes between from 0.5 and 15 μm measured using Malvern Laser Diffraction (data sheets). It is understood that typically huntite particles have a particle size of around 1.0 μm or less, much smaller than the particle size of hydromagnesite particles.

Typically, both hydromagnesite, and huntite particles (b) may be surface treated with any low molecular weight organosilicon compounds disclosed in the art applicable to prevent creping of organosiloxane compositions during processing. For example, organosilanes, polydiorganosiloxanes, or organosilazanes e.g., hexaalkyl disilazane, short chain siloxane diols or fatty acids such as stearic acid or fatty acid esters such as stearates may be used to render the filler(s) hydrophobic and therefore easier to handle and obtain a homogeneous mixture with the other ingredients. Specific examples of the organosilicon compounds include but are not restricted to silanol terminated trifluoropropylmethyl siloxane, silanol terminated vinylmethylsiloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating units of diorganosiloxane in each molecule, hexaorganodisiloxane, hexaorganodisilazane. In one embodiment herein the hydromagnesite and huntite particles are treated with fatty acids e.g., stearic acid or fatty acid esters such as stearates to render the filler(s) hydrophobic. A small amount of water can be added together with the treating agent(s) as a processing aid.

The hydromagnesite, and huntite blend of fillers (b) may be pre-treated prior to introduction into the hydrosilylation curable silicone coating composition or may be treated in situ (i.e., in the presence of at least a proportion of component (a) of the hydrosilylation curable silicone coating composition herein by mixing the fillers into said component (a) together at room temperature or above until the filler is completely treated. When treating the filler blend with fatty acids or fatty acid esters, alternatively with stearic acid or one or more stearates the filler blend is pre-treated and introduced into the composition in a treated and therefore hydrophobic form. Otherwise, untreated filler blend (b) is treated in situ with a treating agent in the presence of organopolysiloxane polymer (a) which results in the preparation of a silicone rubber base material which can subsequently be mixed with other ingredients.

In a preferred embodiment filler blend (b) is free of silica. In a preferred embodiment filler blend (b) is free of calcium carbonate. In a preferred embodiment filler blend (b) is free of silica and calcium carbonate.

Filler blend (b) is present in the composition in an amount of from 5.0 to 40 wt. %. of the composition, alternatively of from 7.5 to 35 wt. %. of the composition, alternatively of from 7.5 to 30 wt. %. of the composition.

### Component (c) Cross-Linker

Component (c) functions as a cross-linker and is provided in the form of an organosilicon compound having at least two, alternatively at least three Si—H groups per molecule. Component (c) normally contains three or more silicon-bonded hydrogen atoms so that the hydrogen atoms can react with the unsaturated groups (alkenyl and/or alkynyl groups) of component (a) and/or the rest of the composition to form a network structure therewith and thereby cure the composition. Some or all of component (c) may alternatively have two silicon bonded hydrogen atoms per molecule.

However, such a molecule is only used as the sole cross-linker when e.g., polymer (a) has greater than two unsaturated groups per molecule in which case a network can be produced during the cure process. Otherwise, when component (c) partially comprises, molecules having two silicon bonded hydrogen atoms per molecule, said molecules may function as a chain extender.

The molecular configuration of the organosilicon compound having at least two, or at least three Si—H groups per molecule (c) is not specifically restricted, and it can be a silane or a straight chain, branched (a straight chain with some branching through the presence of T groups) or cyclic polymer or be silicone resin based.

While the molecular weight of component (c) is not specifically restricted, the viscosity may be measured using the methodology discussed above.

Silicon-bonded organic groups used in component (c) may be exemplified by alkyl groups such as methyl, ethyl, propyl, n-butyl, t-butyl, pentyl, hexyl; aryl groups such as phenyl tolyl, xylyl, or similar aryl groups; 3-chloropropyl, 3,3,3-trifluoropropyl, or similar halogenated alkyl group, preferred alkyl groups having from 1 to 6 carbons, especially methyl ethyl or propyl groups or phenyl groups. Preferably the silicon-bonded organic groups used in component (c) are alkyl groups, alternatively methyl, ethyl or propyl groups.

Examples of the organosilicon compound having at least two, alternatively at least three Si—H groups per molecule (c) include but are not limited to:
(a) trimethylsiloxy-terminated methylhydrogenpolysiloxane,
(b) trimethylsiloxy-terminated polydimethylsiloxane-methylhydrogensiloxane,
(c) dimethylhydrogensiloxy-terminated dimethylsiloxane-methylhydrogensiloxane copolymers,
(d) dimethylsiloxane-methylhydrogensiloxane cyclic copolymers,
(e) copolymers and/or silicone resins consisting of (CH₃)₂HSiO_{1/2} units, (CH₃)₃SiO_{1/2} units and SiO_{4/2} units,
(f) copolymers and/or silicone resins consisting of (CH₃)₂HSiO_{1/2} units and SiO_{4/2} units,
(g) Methylhydrogensiloxane cyclic homopolymers having between 3 and 10 silicon atoms per molecule.

In one embodiment the component (c) is selected from a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; dimethylsiloxane capped at both molecular terminals with dimethylhydrogensiloxy groups; a copolymer of a methylhydrogensiloxane and a dimethylsiloxane capped at both molecular terminals with dimethylhydrogensiloxy groups.

The component (c) cross-linker is generally present in the hydrosilylation curable silicone coating composition such that the molar ratio of the silicon-bonded hydrogen atoms in component (c) to the total unsaturated groups selected from alkenyl and/or alkynyl groups in the composition is from 0.5:1 to 20:1. When this ratio is less than 0.5:1, a well-cured composition will not be obtained. When the ratio exceeds 20:1, there is a tendency for the hardness of the cured composition to increase when heated.

Preferably the cross-linker is present in an amount such that the molar ratio of silicon-bonded hydrogen atoms of component (c) to total unsaturated groups selected from alkenyl and/or alkynyl groups in the organopolysiloxane (a) is preferably at least 1:1 and can be up to 8:1 or 10:1. Most preferably the molar ratio of Si—H groups to aliphatically unsaturated groups is in the range from 1.1:1 to 5:1.

The silicon-bonded hydrogen (Si—H) content of component (c) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27 [H]/[V].

Typically, dependent on the number of unsaturated groups in component (a) and the rest of the composition as well as the number of Si—H groups in component (c), component (c) will be present in an amount of from 0.1 to 20 wt. % of the hydrosilylation curable silicone coating composition, alternatively 0.1 to 15 wt. % of the hydrosilylation curable silicone coating composition, alternatively 0.25 to 10 wt. %, further alternatively from 0.5% to 10 wt. % of the hydrosilylation curable silicone coating composition, alternatively from 0.5% to 10 wt. % of the hydrosilylation curable silicone coating composition.

### (d) Hydrosilylation Catalyst

Component (d) of the hydrosilylation curable silicone coating composition, is a hydrosilylation catalyst comprising or consisting of a platinum group metal or a compound thereof. These are usually selected from catalysts of the platinum group of metals (platinum, ruthenium, osmium, rhodium, iridium and palladium), or a compound of one or more of such metals. Alternatively, platinum and rhodium compounds are preferred due to the high activity level of these catalysts in hydrosilylation reactions, with platinum compounds most preferred. In a hydrosilylation (or addition) reaction, a hydrosilylation catalyst such as component (d) herein catalyses the reaction between an unsaturated group, usually an alkenyl group e.g., vinyl with Si—H groups.

The hydrosilylation catalyst of component (d) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal is platinum.

Examples of preferred hydrosilylation catalysts of component (d) are platinum based catalysts, for example, platinum black, platinum oxide (Adams catalyst), platinum on various solid supports, chloroplatinic acids, e.g., hexachloroplatinic acid (Pt oxidation state IV) (Speier catalyst), chloroplatinic acid in solutions of alcohols e.g., isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g., tetra-vinyl-tetramethylcyclotetrasiloxane-platinum complex (Ashby catalyst). Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution. Platinum catalysts with phosphorus, sulfur, and amine ligands can be used as well, e.g., (Ph₃P)₂PtCl₂; and complexes of platinum with vinylsiloxanes, such as sym-divinyltetramethyldisiloxane (Karstedt's catalyst).

Hence, specific examples of suitable platinum-based catalysts of component (d) include
(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer. Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (d) may be selected from co-ordination compounds of platinum. In one embodiment hexachloroplatinic acid and its conversion products with vinyl-containing siloxanes, Karstedt's catalysts and Speier catalysts are preferred.

The catalytic amount of the hydrosilylation catalyst is generally between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst is provided e.g., in a polymer or solvent, the amount of component (d) present will be within the range of from 0.001 to 3.0 wt. % of the composition, alternatively from 0.001 to 1.5 wt. % of the composition, alternatively from 0.01-1.5 wt. %, alternatively 0.01 to 1.0 wt. %, of the hydrosilylation curable silicone coating composition.

(e) One or More Silicone Resins Containing Unsaturated Groups Selected from Alkenyl Groups, Alkynyl Groups or a Mixture of Alkenyl Groups and Alkynyl Groups

The one or more silicone resins of component (e) in the hydrosilylation curable silicone coating composition are silicone resins containing unsaturated groups selected from alkenyl groups, alkynyl groups or a mixture of alkenyl groups and alkynyl groups, selected from T silicone resins (silsesquioxanes), DT silicone resins, MQ silicone resins, MDT silicone resins, MTQ silicone resins, QDT silicone resins or mixtures thereof.

Such resins of component (e) using the MDTQ notation comprise Q type (SiO_{4/2}) siloxane units T type (R²₁SiO_{3/2}) siloxane units; D type (R²₁SiO_{3/2}) siloxane units and R²□SiO_{1/2} (M) siloxane units as indicated. These resins can be classified into two broad categories: silsesquioxanes and silicates. Silsesquioxanes, or T resins, are predominantly comprised of T units and can be synthesized by the hydrolysis and condensation of alkoxysilanes, chlorosilanes, or mixtures thereof. Silicates, or MQ resins, are predominantly comprised of M and Q units and can be synthesized through the hydrolysis and condensation of alkoxysilanes and chlorosilanes. Alternatively, MQ resins can be synthesized through the polymerization of aqueous alkali silicates in the presence of acid followed by reaction with triorgano alkoxysilanes, triorgano chlorosilanes, hexaorganodisiloxanes or mixtures thereof. Preferably, component (e) is one or more MQ resins. Typically, MQ resins of component (e) comprise SiO_{4/2} (Q) siloxane units and R²□SiO_{1/2} (M) siloxane units wherein each R² may be the same or different and denotes a monovalent group selected from hydrocarbon groups, having from 1 to 20 carbon atoms and, alternatively from 1 to 12 carbon atoms. Examples of suitable R² groups include alkyl groups, such as methyl, ethyl, propyl, pentyl, octyl, undecyl and octadecyl; cycloaliphatic groups, such as cyclohexyl; alkenyl groups, having from 2 to 12 carbons, such as vinyl, propenyl, butenyl, pentenyl, hexenyl, and the like; alkynyl groups selected from ethynyl, propynyl, butynyl, pentynyl or hexynyl and the like; aryl groups such as phenyl, tolyl, xylyl, benzyl, alpha-methyl styryl and 2-phenylethyl; alternatively R² groups are vinyl, methyl, ethyl or phenyl groups, e.g., examples of preferred R²□SiO_{1/2} (M) siloxane units include Me□SiO_{1/2}, PhMe□SiO_{1/2}, ViMe□SiO_{1/2} and Ph□MeSiO_{1/2}, where Me hereinafter denotes methyl, Vi is vinyl and Ph hereinafter denotes phenyl. T silicone resins may alternatively be referred to as silsesquioxanes. The silicone resin can be a single silicone resin or a mixture comprising two or more different silicone resins, each as described above. Typically, they are MQ resins comprising ViMe□SiO_{1/2} In combination with Me□SiO_{1/2}, and/or PhMe□SiO_{1/2} groups.

Additionally, the silicone resin is an MQ resin which may contain residual OZ, where Z can represent hydrogen or alkyl groups. OZ groups remain on the Q components after synthesis of silicone MQ resins indicative of incomplete condensation during the reaction to produce the MQ resin providing the OZ content meets the above hydroxyl per mole Si requirements. Residual OZ is inherent to the processes and reactions utilized to make MQ resins. The MQ resin may also undergo a subsequent silylation reaction to further minimize residual OZ.

The silicone resin (e) is typically delivered in a hydrocarbon or silicone solvent, free from solvent the silicone resin is typically a solid but preferably herein the silicone resin (e) is delivered in a silicone solvent such as a non-functional polydimethylsiloxane or a polydimethylsiloxane comprising two or more alkenyl groups per molecule, such as for example component (a) herein. For example, any suitable MQ resin may be utilized as component (e). The molar ratio of M siloxane units to Q siloxane units has a value of from 0.5:1 to 1.2:1, alternatively 0.6:1 to 1.1:1, alternatively 0.8:1 to 1.1:1, alternatively 0.9:1 to 1.1:1. In one embodiment MQ resin (e) includes a resinous portion wherein the M units are bonded to SiO_{4/2} siloxane units (i.e., Q units) and each of Q units is bonded to at least one other SiO_{4/2} siloxane unit. The molar ratio of M units to Q units is from 0.3:1 to 1.2:1, alternatively 0.4:1 to 1.1:1, alternatively 0.5:1 to 1:1, alternatively 0.6:1 to 0.9:1. Such an MQ resin suitable as component (e) may have a number-average molecular weight (Mn) of from 2000 to 50,000 g/mol, alternatively from 3,000 to 30,000 g/mol. In one embodiment the silicone resin may be described in the terms of a molar fraction as an MQ silicone resin having the formula:

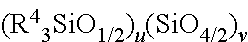

wherein R⁴ is a C₁ to C₁₀ hydrocarbon group free of aliphatic unsaturation, u is from 0.3 to 0.6, alternatively 0.37 to 0.52, v is from 0.4 to 0.7, alternatively 0.48 to 0.63, and the value of u+v is 1.0.

Methods of preparing silicone resins are well known in the art. For example, they may be made by treating a resin copolymer produced by a silica hydrosol capping process with an alkyl and/or alkenyl containing end-blocking agent. This preferably includes reacting a silica hydrosol under acidic conditions with a hydrolysable triorganosilane such as trimethylchlorosilane, a siloxane such as hexamethyldisiloxane, and combinations thereof, and then recovering a copolymer having M (R₃SiO_{1/2}) units and Q (SiO_{4/2}) units including 0.07 to 0.2 moles hydroxyl per mole of silicon (Si). The copolymer may be further reacted with an end-blocking agent including saturated organic groups to achieve the less than 0.06 moles hydroxyl per mole Si. Suitable end-blocking agents include silazanes, siloxanes, silanes, and combinations thereof.

Component (e) may be present in the composition in an amount of from 1-60 wt. %, alternatively 1-40 wt. %, and is an MQ resin or a T-resin (silsesquioxane), most preferably, an MQ resin.

Components (a), (c) and (e) invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer and/or resin can be determined by Gel permeation chromatography (GPC) using polystyrene calibration standards. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity. The silicone resin typically has a weight-average molecular weight (M_{w}) of from 2,000 to 50,000 Daltons, alternatively from 3,000 to 45,000, alternatively from 3,000 to 40,000, alternatively from 4,000 to 30,000, alternatively 5,000 to 30,000 where the molecular weight is determined by gel permeation chromatography employing a triple detector system e.g., light-scattering detector, a refractive index detector, and/or a viscosity detector and polystyrene standards. In one embodiment component (e) may be introduced into the composition in a mixture with all or part of component (a).

### (f) Adhesion Promoter

The hydrosilylation curable silicone coating composition used to prepare the coating for the one-piece woven airbag additionally comprises an adhesion promoter (f). Adhesion promoter (f) may be any suitable adhesion promoter that will not be detrimental to the mechanical properties of the cured coating on the airbag. For example, one or more monoacrylates, diacrylates or methacrylates. Examples may include for diacrylates such as C₄₋₂₀ alkanediol diacrylate such as hexanediol diacrylate, heptanediol diacrylate, octanediol diacrylate, nonanediol diacrylate, and or undecanediol diacrylate. Examples of monoacrylates include alkoxysilanes containing methacrylic groups or acrylic groups such as methacryloxymethyl-trimethoxysilane, 3-methacryloxypropyl-trimethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane.

Examples of epoxy-containing alkoxysilanes which may be used as adhesion promoter may include 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl)ethyltrimethoxysilane, or 2-(3,4-epoxycyclohexyl)ethyltriethoxysilane.

The adhesion promoter (f) may alternatively include one or more alkoxysilanes in combination with an organometallic condensation reaction catalyst such as organotitanium (titanates), organoaluminum (aluminates) or organozirconium compounds (zirconates).

In such a case the alkoxysilane may contain methacrylic groups or acrylic groups such as methacryloxymethyl-trimethoxysilane, 3-methacryloxypropyl-trimethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane.

The organometallic condensation reaction catalyst comprising organoaluminum organozirconium or organotitanium compounds which may be used herein may be selected from organometallic catalyst comprising zirconates, titanates, organoaluminium chelates, zirconium chelates and/or titanium chelates.

Zirconate and titanate-based catalysts may comprise a compound according to the general formula Zr[OR⁵]₄ or Ti[OR⁵]₄ where each R⁵ may be the same or different and represents a monovalent, primary, secondary or tertiary aliphatic hydrocarbon group which may be linear or branched containing from 1 to 20 carbon atoms, alternatively 1 to 10 carbon atoms. Optionally the zirconate/titanate may contain partially unsaturated groups. Preferred examples of R⁵ include but are not restricted to methyl, ethyl, propyl, isopropyl, butyl, tertiary butyl and a branched secondary alkyl group such as 2,4-dimethyl-3-pentyl. Preferably, when each R⁵ is the same, R⁵ is an isopropyl, branched secondary alkyl group or a tertiary alkyl group, in particular, tertiary butyl. Specific zirconium-based examples include, zirconium tetrapropylate and zirconium tetrabutyrate, tetra-isopropyl zirconate, zirconium (IV) tetraacetyl acetonate, (sometimes referred to as zirconium AcAc₄), zirconium (IV) hexafluoracetyl acetonate, zirconium (IV) trifluoroacetyl acetonate, tetrakis (ethyltrifluoroacetyl acetonate) zirconium, tetrakis (2,2,6,6-tetramethyl-heptanethionate) zirconium, zirconium (IV) dibutoxy bis(ethylacetonate), zirconium tributoxyacetylacetate, zirconium butoxyacetylacetonate bisethylacetoacetate, zirconium butoxyacetylacetonate bisethylacetoacetate, diisopropoxy bis (2,2,6,6-tetramethyl-heptanethionate) zirconium, or similar zirconium complexes having β-diketones (including alkyl-substituted and fluoro-substituted forms thereof) which are used as ligands.

Specific titanium-based examples include, titanium tetrapropylate and titanium tetrabutyrate, tetra-isopropyl zirconate, titanium (IV) tetraacetyl acetonate, (sometimes referred to as titanium AcAc₄), titanium (IV) hexafluoracetyl acetonate, titanium (IV) trifluoroacetyl acetonate, tetrakis (ethyltrifluoroacetyl acetonate) titanium, tetrakis (2,2,6,6-tetramethyl-heptanethionate) titanium, titanium (IV) dibutoxy bis(ethylacetonate), titanium tributoxyacetylacetate, titanium butoxyacetylacetonate bisethylacetoacetate, titanium butoxyacetylacetonate bisethylacetoacetate, diisopropoxy bis (2,2,6,6-tetramethyl-heptanethionate) titanium, or similar titanium complexes having β-diketones (including alkyl-substituted and fluoro-substituted forms thereof) which are used as ligands.

Suitable aluminium-based condensation catalysts may include but are not limited to one or more of Al(OC₃H₇)₃, Al(OC₃H₇)₂ (C₃COCH₂COC₁₂H₂₅), Al(OC₃H₇)₂(OCOCH₃), and Al(OC₃H₇)₂(OCOC₁₂H₂₅).

The organometallic condensation reaction catalyst may be present in the composition in an amount of from 0.1 to 5% by weight of the composition, alternatively 0.1 to 3% by weight, alternatively 0.1 to 2% by weight of the composition. When adhesion promoter (f) is comprises a cumulative amount of (f)(i), (ii) and (iii), it may comprise from about 0.3 to 6 wt. % of the composition; alternatively, 0.3 to 4 wt. % of the composition.

In one alternative, the adhesion promoter (f) may alternatively include an adhesion promoter comprising a mixture and/or reaction product of
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst as described above.

In such a case (f)(i) the one or more alkoxysilanes having an epoxy group in the molecule may be 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl)ethyltrimethoxysilane, or 2-(3,4-epoxycyclohexyl)ethyltriethoxysilane; and (f)(ii) the linear organopolysiloxane oligomer containing at least one alkenyl group and at least one hydroxy or alkoxy group per molecule can for example be a methylvinylpolysiloxane in which both molecular terminals are dimethylhydroxysiloxy units, or a copolymer of a methylvinyl siloxane and dimethylsiloxane units in which both molecular terminals are dimethylhydroxysiloxy units; and the oligomeric organopolysiloxane can be a mixture of organopolysiloxane molecules, some of which have silanol end groups at both molecular terminals and some of which have only one silanol group such as a dimethylhydroxysiloxy terminal unit with the other terminal unit being for example a dimethylmethoxysiloxy unit, a trimethylsiloxy unit or a dimethylvinylsiloxy unit. Preferably more than 50% by weight of the oligomeric organopolysiloxane, more preferably 60-100% comprises molecules having silanol end groups at both molecular terminals.

The oligomeric organopolysiloxane preferably contains at least 3%, more preferably at least 5%, by weight vinyl groups, and can contain up to 25 or 30% by weight vinyl groups. Most preferably the oligomeric organopolysiloxane contains 5 to 20% by weight vinyl groups. The oligomeric organopolysiloxane preferably has a molecular weight of 300 to 10000. The oligomeric organopolysiloxane preferably has a viscosity of from 0.1 to 300 mPa·s, alternatively a viscosity of 0.1 to 200 mPa·s, alternatively from 1 to 100 mPa·s. measured using a Brookfield DV III rotational viscometer at 25° C. using spindle CP-52 at 12 rpm. Component (f)(ii) may be present in the composition in an amount of from 0.1 to 5% by weight of the composition, alternatively 0.1 to 3% by weight, alternatively 0.1 to 2% by weight of the composition.

(f)(iii) is an organometallic condensation reaction catalyst as described above in an amount given above.

The adhesion promoter provides a strong bonding performance between the resulting coating and the fabric substrate, including woven fabrics.

### Additional Optional Ingredients

Additional optional ingredients may be present in the liquid silicone rubber composition as hereinbefore described depending on the intended final use thereof. Examples of such optional ingredients include cure inhibitors thermally conductive fillers, pot life extenders, flame retardants, lubricants, pigments and/or colouring agents, bactericides, wetting agents, heat stabilizers, compression set additives, plasticizers, and mixtures thereof.

### Cure Inhibitors

When the hydrosilylation curable silicone coating composition as hereinbefore described is being cured via an addition/hydrosilylation reaction an inhibitor may be utilized to inhibit the cure of the composition. These inhibitors are utilized to prevent premature cure in storage and/or to obtain a longer working time or pot life of a hydrosilylation cured composition by retarding or suppressing the activity of the catalyst. Inhibitors of hydrosilylation catalysts (d), e.g., platinum metal-based catalysts are well known in the art and may include hydrazines, triazoles, phosphines, mercaptans, organic nitrogen compounds, acetylenic alcohols, silylated acetylenic alcohols, maleates, such as dibutyl maleate; fumarates, ethylenically or aromatically unsaturated amides, ethylenically unsaturated isocyanates, olefinic siloxanes, such as tetramethyltetravinylcyclotetrasiloxane; unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

One class of known inhibitors of hydrosilylation catalysts, e.g., platinum catalysts (d) include the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-methyl butynol 3-butyn-2-ol, propargyl alcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, and mixtures thereof. In one alternative the inhibitor is selected from one or more of 1-ethynyl-1-cyclohexanol (ETCH), tetramethyltetravinylcyclotetrasiloxane, 3-methyl butynol and/or dibutyl maleate.

When present, inhibitor concentrations as low as one mole of inhibitor per mole of the metal of catalyst (d) will in some instances impart satisfactory storage stability and cure rate. In other instances, inhibitor concentrations of up to five hundred moles of inhibitor per mole of the metal of catalyst (d) are required. The optimum concentration for a given inhibitor in a given hydrosilylation curable silicone coating composition herein is readily determined by routine experimentation. Mixtures of the above may also be used. Dependent on the concentration and form in which the inhibitor selected is provided/available commercially, when present in the composition, the inhibitor is typically present in an amount of from 0.0001-10 wt. %, alternatively 0.001-5%, inhibitor, alternatively 0.0125 to 5 wt. % of the composition.

### Pot Life Extenders

Pot life extenders, such as triazole, may be used.

### Flame Retardants

Examples of flame retardants include aluminium trihydrate, chlorinated paraffins, hexabromocyclododecane, triphenyl phosphate, dimethyl methylphosphonate, tris(2,3-dibromopropyl) phosphate (brominated tris), and mixtures or derivatives thereof.

### Lubricants

Examples of lubricants include tetrafluoroethylene, resin powder, graphite, fluorinated graphite, talc, boron nitride, fluorine oil, silicone oil, molybdenum disulfide, and mixtures or derivatives thereof. When present in the composition, flame retardants are typically present in an amount of from 0.1 to 5% by weight of the composition.

### Pigments and Colouring Agents

Examples of pigments include titanium dioxide, chromium oxide, bismuth vanadium oxide, iron oxides and mixtures thereof.

Examples of colouring agents for which may be utilized in the hydrosilylation curable silicone coating composition include pigments, vat dyes, reactive dyes, acid dyes, chrome dyes, disperse dyes, cationic dyes and mixtures thereof. The two-part moisture cure organopolysiloxane composition as described herein may further comprise one or more pigments and/or colorants which may be added if desired. The pigments and/or colorants may be coloured, white, black, metal effect, and luminescent e.g., fluorescent and phosphorescent. Pigments are utilized to colour the composition as required. Any suitable pigment may be utilized providing it is compatible with the composition herein. In two-part moisture cure organopolysiloxane compositions pigments and/or coloured (non-white) fillers e.g., carbon black may be utilized in the catalyst package to colour the end sealant product.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g., phthalocyanine blue and phthalocyanine green; monoarylide yellow, diarylide yellow, benzimidazolone yellow, heterocyclic yellow, DAN orange, quinacridone pigments, e.g., quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm. The pigments and/or colorants when present are present in the range of from 2, alternatively from 3, alternatively from 5 to 20 wt. % of the catalyst package composition, alternatively to 15 wt. % of the catalyst package composition, alternatively to 10 wt. % of the catalyst package composition.

In a preferred embodiment when present, the pigments and dyes are used in form of pigment masterbatch composed of them dispersed in component (a) at the ratio of 25:75 to 70:30.

### Heat Stabilizers

Examples of heat stabilizers may include metal compounds such as red iron oxide, yellow iron oxide, ferric hydroxide, cerium oxide, cerium hydroxide, lanthanum oxide, copper phthalocyanine, aluminium hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. Other examples of heat stabilizers may include suitable antioxidants or metal scavengers such as salicyloylaminotriazole, 1,2-bis(3,5-di-tert-butyl-4-hydroxylhydrocinnamoyl) hydrazine, 2-Hydroxy-N-1H-1,2,4-triazol-3-ylbenzamide, and N′1,N′12-Bis(2-hydroxybenzoyl) dodecanedihydrazide. The amount of heat stabilizer when present in a composition may range from 0.01 to 1.0% weight of the total composition.

In a preferred embodiment the composition is free of silica. In a preferred embodiment the composition is free of calcium carbonate. In a preferred embodiment the composition is free of silica and calcium carbonate.

In one embodiment the hydrosilylation curable silicone coating composition comprises:
a) an organopolysiloxane polymer having a viscosity of from 100 and 200,000 mPa·s at 25° C., alternatively between 1000 and 150,000 mPa·s at 25° C., alternatively, from 1000 mPa·s to 125,000 mPa·s, alternatively from 1000 mPa·s to 100,000 mPa·s at 25° C. (measured in accordance with ASTM D 1084 Method B using a Brookfield DV III rotational viscometer with the most appropriate spindle CP-52 for the viscosity being measured at 1 rpm), having at least two unsaturated groups per molecule selected from alkenyl and/or alkynyl groups, in an amount of from 40 wt. % to about 80 wt. % of the composition, alternatively from 45 to 80 wt. % of the composition, alternatively from 50 to 80 wt. % of the composition of the composition;
b) a filler blend of hydromagnesite and huntite which filler blend may be treated with a suitable hydrophobing agent such as, for example with fatty acids or fatty acid esters such as stearates typically treated to render them hydrophobic and are present in an amount of from 5.0 to 40 wt. %. of the composition, alternatively of from 7.5 to 35 wt. %. of the composition, alternatively of from 7.5 to 30 wt. %. of the composition;
c) an organosilicon compound having at least two, alternatively at least three Si—H groups per molecule, preferably wherein the molar ratio of the silicon-bonded hydrogen atoms in component (c) to the total unsaturated groups selected from alkenyl and/or alkynyl groups in the composition is from 0.5:1 to 20:1, alternatively the molar ratio of silicon-bonded hydrogen atoms of component (c) to the total unsaturated groups selected from alkenyl and/or alkynyl groups in the organopolysiloxane (a) is preferably at least 1:1 and can be up to 8:1 or 10:1. Most preferably the molar ratio of Si—H groups to aliphatically unsaturated groups is in the range from 1.1:1 to 5:1; said organosilicon compound having at least two, alternatively at least three Si—H groups per molecule being present in an amount of from 0.1 to 20 wt. % of the hydrosilylation curable silicone coating composition, alternatively 0.1 to 15 wt. % of the hydrosilylation curable silicone coating composition, alternatively 0.25 to 10 wt. %, further alternatively from 0.5% to 10 wt. % of the hydrosilylation curable silicone coating composition. Component (c) functions as a cross-linker.
d) a hydrosilylation cure catalyst wherein the catalytic amount of the hydrosilylation catalyst is between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm; alternatively 0.01 to 750 ppm, alternatively 0.01 to 500 ppm and alternatively 0.01 to 100 ppm of metal based on the weight of the composition and wherein dependent on the form/concentration in which the catalyst is provided e.g., in a polymer or solvent, the amount of component (d) present will be within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the hydrosilylation curable silicone coating composition;
e) one or more silicone resins containing unsaturated groups selected from alkenyl groups, alkynyl groups or a mixture of alkenyl groups and alkynyl groups, selected from T silicone resins (silsesquioxanes), DT silicone resins, MQ silicone resins, MDT silicone resins, MTQ silicone resins, QDT silicone resins or mixtures thereof, in an amount of from 1-60 wt. %, alternatively 1-40 wt. % of the composition;
f) an adhesion promoter selected from one or more monoacrylates, diacrylates or methacrylates; epoxy-containing alkoxysilanes, vinyl-containing alkoxysilanes, alkoxysilane containing methacrylic groups or acrylic groups and a mixture and/or reaction product of
   i) one or more alkoxysilanes having an epoxy group in the molecule in an amount of from 0.1 to 5% by weight of the composition, alternatively 0.5 to 3% by weight, alternatively 0.5 to 2% by weight of the composition;
   ii) a linear organopolysiloxane oligomer containing at least one alkenyl group and at least one hydroxy or alkoxy group per molecule in an amount of from 0.1 to 5% by weight of the composition, alternatively 0.1 to 3% by weight, alternatively 0.1 to 2% by weight of the composition; and
   iii) an organometallic condensation reaction catalyst comprising organotitanium, organoaluminum or organozirconium compounds in an amount of from 0.1 to 5% by weight of the composition, alternatively 0.1 to 3% by weight, alternatively 0.1 to 2% by weight of the composition; or a mixture thereof;
      which adhesion promoter (f) is typically present in the composition in a cumulative amount of (f)(i), (ii) and (iii) of from about 0.3 to 6 wt. % of the composition; alternatively, 0.3 to 4 wt. % of the composition; the composition may be any combination of the above ranges providing the total wt. % is 100 wt. %.

Typically, when stored prior to use the hydrosilylation curable silicone coating composition utilized to coat the material and/or airbag is stored in two parts, Part A and part B to keep components (c) (cross-linker) and (d) hydrosilylation cure catalyst apart to avoid premature cure. Typically, a Part A composition will comprise components (a) polymer, (b) filler blend and (d) hydrosilylation cure catalyst.

Part B will comprise components (a), (b) and (c) cross-linker and inhibitor when present.

Component (e), the one or more silicone resins containing unsaturated groups selected from alkenyl groups, alkynyl groups or a mixture of alkenyl groups and alkynyl groups e.g., one or more MQ resin, may be present in Part A, part B or parts A and B as desired. Regarding the adhesion promoter, when utilizing the reaction product of (f)(i), (f)(ii) and (f)(iii), to prevent premature reaction, component f) (iii) is usually stored in part A and components f (i) and (ii) are stored in part B.

Additives, when present in the composition, may be in either Part A or Part B, providing they do not negatively affect the properties of any other component (e.g., catalyst inactivation). Part A and part B of the hydrosilylation curable silicone coating composition described herein are mixed together shortly prior to use to initiate cure of the full composition into a silicone elastomeric material. The compositions can be designed to be mixed in any suitable weight ratio e.g., part A:part B may be mixed together in ratios of from 10:1 to 1:10, alternatively from 5:1 to 1:5, alternatively from 2:1 to 1:2, but most preferred in a weight ratio of 1:1.

Ingredients in each of Part A and/or Part B may be mixed together individually or may be introduced into the composition in pre-prepared in combinations for, e.g., ease of mixing the final composition. For Example, components (a) and (b) are often mixed together to form an LSR polymer base or masterbatch prior to addition with other ingredients. These may then be mixed with the other ingredients of the Part being made directly or may be used to make pre-prepared concentrates commonly referred to in the industry as masterbatches.

In this instance, for ease of mixing ingredients, one or more masterbatches may be utilized to successfully mix the ingredients to form Part A and/or Part B compositions.

Parts A and B of the composition may be prepared by combining all of their respective components at ambient temperature. Any mixing techniques and devices described in the prior art can be used for this purpose. The particular device to be used will be determined by the viscosities of components and the final composition. Suitable mixers include but are not limited to paddle type mixers e.g., planetary mixers and kneader type mixers. Cooling of components during mixing may be desirable to avoid premature curing of the composition.

Prior to use the respective Part A and Part B compositions are mixed together in the desired ratio. As part of the method herein the coating composition as hereinbefore described may be applied on to a textile material or airbag substrate e.g, a one-piece woven (OPW) airbag substrate or textile material for a cut-and-sewn, seam-sealed (CSSS) airbag by any suitable known technique. These include spraying, gravure coating, bar coating, coating by knife-over-roller, coating by knife-over-air, padding, dipping and screen-printing.

The hydrosilylation curable silicone coating composition is designed to be used for coating either cut-and-sewn, seam-sealed (CSSS) airbag textiles or to a one-piece woven (OPW) airbag to be used as frontal airbags and/or front-centre airbags, designed to act as a cushion at a point of impact especially in collisions with the front or back of the vehicle, i.e. frontal or rear collisions.

Curing of the hydrosilylation curable silicone coating composition after having been applied onto the woven fabric is typically undertaken by heating the composition at a temperature of from 150 to 200° C. up to 5 minutes, alternatively for 30 seconds to 2 minutes.

Although it is not preferred, it is possible to apply the composition in multiple layers. Typically, the hydrosilylation curable silicone coating composition will not require a base coat between it and the textile material and furthermore whilst it is also possible to apply onto the resulting coating a topcoat, it is generally considered unnecessary.

The present disclosure includes a textile material or airbag substrate e. g, a one-piece woven (OPW) airbag substrate or a cut-and-sewn, seam-sealed (CSSS) airbag having a cured coating of the hydrosilylation curable silicone coating composition thereon having a mean dry coat weight of from 10 g/m² to 50 g/m², alternatively from 15 to 40 g/m², alternatively from 15 g/m² to 35 g/m2 g/m², alternatively from 20 g/m² to 35 g/m², determined in accordance with ISO 3801.

The textile material or airbag substrate e.g, a one-piece woven (OPW) airbag substrate or a cut-and-sewn, seam-sealed (CSSS) airbag may be made from any suitable woven fabric, particularly a plain weave fabric, but can for example be a knitted or nonwoven fabric. The fabric may be made from synthetic fibres or blends of natural and synthetic fibres, for example polyamide fibres such as Nylon 6, Nylon 66 and Nylon 46; polyester fibers such as polyethylene terephthalate and polybutylene terephthalate; polyimide, polyethylene, polypropylene, polyester-cotton, polyacrylonitrile fiber fabric, aramid fiber fabric, polyether imide fiber fabric, polysulfone fiber fabric, carbon fiber fabric, rayon fiber fabric and/or glass fibres. For example, it is preferable to use polyamide fiber fabric or polyester fiber fabric for applications requiring high strength, such as automotive one-piece woven airbags.

Prior to being coated with the liquid curable silicone rubber composition substrate is preferably washed with water and dried.

For use as one-piece woven airbag textile material, the textile material should be sufficiently flexible to be able to be folded into relatively small volumes, but also sufficiently strong to withstand deployment at high speed, e.g., under the influence of an explosive charge. Polyamide and polyester fibres are particularly preferred for making airbag textiles; however, it can be difficult to get coatings to adhere to polyamide and polyester airbags, hence the need for adhesion promoters such as component (f) in the compositions described above as the coating compositions as hereinbefore described need to have good adhesion to plain weave nylon and polyester textile materials. The coating compositions described herein are designed therefore to have particularly good adhesion and film forming properties immediately on contacting the textile material, so that film formation on the surface of the textile material being coated is uniform. Preferably they also have good penetration into the textile material in order for the ability to achieve the desired mean dry coat weight, e.g., 10 g/m² to 50 g/m², alternatively from 15 to 40 g/m², alternatively from 15 g/m² to 35 g/m² g/m², alternatively from 20 g/m² to 35 g/m², determined in accordance with ISO 3801 as previously indicated.

It was found that the uses of the hydromagnesite and huntite blend of fillers (b) instead of silica reinforcing fillers and/or calcium carbonate fillers in a coating gave surprisingly good results in/on textile material/airbag coatings cured from the hydrosilylation curable silicone coating compositions described herein. Prior to cure said compositions had good flowability on the substrate surfaces enabling acceptably thin coatings on the substrate after curing because the hydromagnesite and huntite blend of fillers (b) did not cause a problematic shear thinning effect. However, the resulting cured coatings on the textile material/airbag maintained good mechanical property results after cure, e.g., modulus at 100% extension as well as good, flame resistance and advantageously improved edgecomb resistance.

Hence, coating compositions utilising a blend of hydromagnesite and huntite as the fillers in the hydrosilylation curable silicone coating compositions described herein can be used as coatings for textile materials such as for screen printing, as a base coating for silicone leather, as a binder layer coating between a textile and a silicone coating and especially for coating materials used in or for airbags e.g. cut-and-sewn, seam-sealed (CSSS) airbags or one-piece woven airbags design and airbags of both types especially those used to cushion vehicle occupants after a frontal or rear collision rather than for side airbags which tend to require comparatively longer inflation periods but also for e.g., escape chutes from aircraft. The hydrosilylation curable silicone coating compositions herein are designed to be coated directly onto the material/airbag and would not generally be used as a topcoat on top of intermediate coatings applied directly onto the fabric/airbag. Furthermore, such coatings as described herein would not require a topcoat applied thereto in order to function.

### EXAMPLES

In the following examples, the hydrosilylation curable silicone coating compositions are defined in weight % (wt. %) unless otherwise stated.

Vinyl group and Si—H group content was measured by Infrared spectroscopy in accordance with ASTM E168 using standards of the carbon double bond stretch and silicon-hydrogen bond stretch respectively.

### Determination of Viscosity

Unless otherwise indicated all viscosity measurements given for individual ingredients are measured in accordance with ASTM D 1084 Method B using a Brookfield DV III rotational viscometer with the most appropriate spindle CP-52 for the viscosity being measured at specific rpm.

The compositions of comparative examples C. 1 to 6 and the Examples, Ex. 1 to 6 are disclosed in Tables 1a and 1b respectively.

TABLE 1a
Compositions of Comparative examples 1 to 6 (wt. %)

| Ingredient Type | C. 1 | C. 2 | C. 3 | C. 4 | C. 5 | C. 6 |
|---|---|---|---|---|---|---|
| Polymer 1 | 60.01 | 30.06 | | | 20.06 | 10.06 |
| Silicone Resin 1 | 36.00 | 65.00 | 94.06 | 65.00 | 65.00 | 65.00 |
| LSR Base | | | | 30.06 | | |
| CaCO₃ | | | | | 10.00 | 20.00 |
| Cross-linker 1 | 2.15 | 3.10 | 4.10 | 3.10 | 3.10 | 3.10 |
| Ethynyl Cyclohexanol (ETCH) | 0.02 | 0.02 | 0.02 | 0.02 | 0.02 | 0.02 |
| Karstedt's Catalyst (5,000 ppm Pt) | 0.32 | 0.32 | 0.32 | 0.32 | 0.32 | 0.32 |
| Adhesion Catalyst | 0.80 | 0.80 | 0.80 | 0.80 | 0.80 | 0.80 |
| Glycidoxypropyltrimethoxysilane | 0.70 | 0.70 | 0.70 | 0.70 | 0.70 | 0.70 |
| H/Vi Ratio | 1.6:1 | 1.6:1 | 1.6:1 | 1.6:1 | 1.6:1 | 1.6:1 |

### In Table 1a:

Polymer 1 was a dimethylvinylsiloxy-terminated Dimethyl Siloxane having a 0.085 wt. % Vinyl content and a viscosity of 57,000 mPa·s at 25° C. (ASTM D 1084 Method B, spindle CP-52, 1 rpm).

Silicone Resin 1 was a mixture of and 27 wt. % of an MQ resin (M₃₇M^{Vi}₅Q₅₈OH₈) in polymer 1 which has a viscosity of 60,000 mPa·s at 25° C. (ASTM D 1084 Method B, spindle CP-52, 1 rpm).

LSR Base 1 was a combination of 27 wt. % fumed silica in polymer 1.

CaCO₃ was Hakuenka™ CC-R a precipitated calcium carbonate coated with fatty acids commercially available from Shiraishi Calcium Kaisha, Ltd.

Cross-linker 1 was a trimethyl terminated Dimethyl, methylhydrogen siloxane having a viscosity of about 15 mPa·s at 25° C. (ASTM D 1084 Method B, spindle CP-52, 10 rpm.

Adhesion Catalyst was 50 wt. % Zirconium (IV) acetylacetonate (Zr(AcAc)₄) in 50 wt. % of a dimethylvinyl terminated polydimethylsiloxane having a viscosity of about 9000 mPa·s at 25° C. (ASTM D 1084 Method B, spindle CP-52, 3 RPM) and a vinyl content of 0.225%.

TABLE 1b
Compositions of Ex. 1 to 6 (wt. %)

| Ingredient Type | Ex. 1 | Ex. 2 | Ex. 3 | Ex. 4 | Ex. 5 | Ex. 6 |
|---|---|---|---|---|---|---|
| Polymer 1 | 20.06 | 10.06 | 20.06 | 10.06 | 20.06 | 10.06 |
| Silicone Resin 1 | 65.00 | 65.00 | 65.00 | 65.00 | 65.00 | 65.00 |
| HMH 1 | 10.00 | 20.00 | | | | |
| HMH 2 | | | 10.00 | 20.00 | | |
| HMH 3 | | | | | 10.00 | 20.00 |
| Cross-linker 1 | 3.10 | 3.10 | 3.10 | 3.10 | 3.10 | 3.10 |
| Ethynyl Cyclohexanol (ETCH) | 0.02 | 0.02 | 0.02 | 0.02 | 0.02 | 0.02 |
| Karstedt's Catalyst (5,000 ppm Pt) | 0.32 | 0.32 | 0.32 | 0.32 | 0.32 | 0.32 |
| Adhesion Catalyst | 0.80 | 0.80 | 0.80 | 0.80 | 0.80 | 0.80 |
| Glycidoxypropyltrimethoxysilane | 0.70 | 0.70 | 0.70 | 0.70 | 0.70 | 0.70 |
| H/Vi Ratio | 1.6:1 | 1.6:1 | 1.6:1 | 1.6:1 | 1.6:1 | 1.6:1 |

The components of Ex. 1 to 6 are the same as indicated above with the exception of the use of three alternative blends of hydromagnesite and huntite.

HMH 1 was a blend of hydromagnesite and huntite surface treated with stearic acid which commercially available as UltraCarb™ 1251 from LKAB Minerals AB of Lulea, Sweden.

HMH 2 was a blend of hydrophobically treated hydromagnesite and huntite commercially available as UltraCarb™ 1253 from LKAB Minerals AB of Lulea, Sweden.

HMH 3 was a blend of hydromagnesite and huntite surface treated with stearic acid commercially available as UltraCarb™ LH3C from LKAB Minerals AB of Lulea, Sweden.

### Sample Preparation Processes

For the sake of these laboratory examples the compositions were not prepared in two parts as they were utilised immediately. In a commercial situation they would have been prepared in two parts to prevent cure in storage.

Polymer 1 and silicone resin 1 were initially premixed together in all comparatives and examples excepting for C. 3 (no polymer 1) and C. 4 when silicone resin 1 and LSR base were initially mixed together in a FlackTek SpeedMixer, model number is DAC 400.2 VAC-LR. The remaining components of each composition of the comparative examples and Examples were then added and mixed into the composition using the speedmixer.

The viscosity of the resulting compositions was assessed at three alternative shear rates in accordance with the Dow Silicones Corporation Corporate Test Method CTM 1094 at 25° C. (available to the public upon request) using an AR 2000 rheometer from TA Instruments The results are depicted in Tables 2a (comparative examples and Table 2b Examples below.

TABLE 2a
Rheology testing of C. 1 to 6 at 25° C. in
accordance with CTM 1094 (Pa · s)

| Tested Property | C. 1 | C. 2 | C. 3 | C. 4 | C. 5 | C. 6 |
|---|---|---|---|---|---|---|
| Viscosity (0.1/s) | 54 | 47 | 44 | 395 | 55 | 73 |
| Viscosity (1.0/s) | 55 | 48 | 45 | 210 | 56 | 74 |
| Viscosity (10.0/s) | 54 | 48 | 45 | 118 | 55 | 70 |

TABLE 2b
Rheology testing of Ex. 1 to 6 at 25° C. in
accordance with CTM 1094) (Pa · s)

| Tested Property | Ex. 1 | Ex. 2 | Ex. 3 | Ex. 4 | Ex. 5 | Ex. 6 |
|---|---|---|---|---|---|---|
| Viscosity (0.1/s) | 55 | 74 | 56 | 73 | 56 | 72 |
| Viscosity (1.0/s) | 56 | 75 | 56 | 74 | 56 | 72 |
| Viscosity (10.0/s) | 55 | 72 | 55 | 71 | 55 | 69 |

It can be seen that the compositions herein have consistent viscosity values at different shear rates indicating that the blend of hydromagnesite and huntite does not create a shear thinning effect. In contrast comparative C. 4 shows a significant shear thinning effect when the only filler present is fumed silica.

The compositions of the Examples and comparatives were then assessed for their mechanical and coating properties.

Mechanical property testing was undertaken using 2 mm thick sheets of the cured product of each Example and comparative example compositions. The sheets were prepared by compression molding being cured at about 120° C., for a period of 10 min. Samples were not post cured.

### Methods Used Herein for Measuring Mechanical Properties of Silicone Rubber

Hardness of the silicone rubber samples prepared and cured as described above was measured by Shore A durometer in accordance with ASTM D 2240. Tensile strength, elongation at break and modulus at 100% extension were determined in accordance with ASTM D412.

Tear strength was determined in accordance with ASTM D624 utilising Die B.

Specific gravity was determined in accordance with ASTM D792.

The results of the mechanical property testing are depicted in Tables 3a and 3b below.

TABLE 3a
Mechanical Properties of the Comparative Examples C. 1 to 6

| Tested Property | C. 1 | C. 2 | C. 3 | C. 4 | C. 5 | C. 6 |
|---|---|---|---|---|---|---|
| Hardness (Shore A | 22 | 31 | 43 | 40 | 41 | 49 |
| Tensile strength (MPa) | 1.7 | 3.7 | 5.1 | 5.7 | 3.8 | 4.1 |
| Elongation at break (%) | 215 | 316 | 392 | 550 | 314 | 342 |
| Modulus at 100% extension (MPa) | 0.46 | 1.28 | 2.98 | 1.51 | 1.94 | 2.48 |
| Tear strength (kN/m) | 6.84 | 14.60 | 24.65 | 31.84 | 14.87 | 17.46 |
| Specific gravity (g/cm³) | 0.986 | 1.002 | 1.016 | 1.052 | 1.064 | 1.144 |

TABLE 3b
Mechanical Properties of the Examples Ex. 1 to 6

| Tested Property | Ex. 1 | Ex. 2 | Ex. 3 | Ex. 4 | Ex. 5 | Ex. 6 |
|---|---|---|---|---|---|---|
| Hardness (Shore A) | 39 | 48 | 38 | 46 | 40 | 48 |
| Tensile strength (MPa) | 4.3 | 4.7 | 4.3 | 4.5 | 3.7 | 4.2 |
| Elongation at break (%) | 337 | 412 | 350 | 370 | 292 | 356 |
| Modulus at 100% extension (MPa) | 2.13 | 2.56 | 1.97 | 2.57 | 1.86 | 2.33 |
| Tear strength (kN/m) | 18.22 | 19.12 | 19.90 | 24.65 | 18.79 | 23.36 |
| Specific gravity (g/cm³) | 1.072 | 1.148 | 1.070 | 1.147 | 1.066 | 1.141 |

It can be seen that the mechanical properties were retained when using a blend of hydromagnesite and huntite.

Coated fabric testing according to according to European Airbag Standardization Committee (EASC) instruction No 99040180 (dated 11 Dec. 2009) Coated textile material samples were prepared in accordance and evaluated in accordance with EASC 99040180. Coatings were applied using the composition of each example and comparative example compositions on a 470 dtex Nylon (PA66) textile material. Compositions were coated onto the 470 dtex Nylon (PA66) textile material using a Mathis Lab Coater, commercially available from Werner Mathis U.S.A. Inc., USA. The coating temperature used was 190° C. for a coating time of Imin with a wet coating weight of 25 gm². The fabric was coated on the warp direction.

Tests were then carried out on textile material samples coated with cured coatings made from compositions of comparatives C. 1 to 6 and Ex. 1 to 6 to test 3 samples in warp and weft directions with respect to 3.12 Flammability in accordance with ISO 3795, 3.15 Edgecomb Resistance in accordance with ASTM D6479 and 3.25 Flex Abrasion in accordance with ISO 5981 with the results depicted in Tables 4a and b, Tables 5a and b and Tables 6a and b respectively.

TABLE 4a
Flammability in accordance with ISO 3795 with respect
to coatings made using Comparatives C. 1 to 6
on 470 dtex Nylon textile material (mm/min)

| | Target | C. 1 | C. 2 | C. 3 | C. 4 | C. 5 | C. 6 |
|---|---|---|---|---|---|---|---|
| Warp average | <80 | 106 | 75 | 83 | 74 | 58 | 38 |
| Weft average | <80 | 97 | 83 | 64 | 69 | 49 | 29 |

TABLE 4b
Flammability in accordance with ISO 3795 with respect to coatings
made using Ex. 1 to 6 on 470 dtex Nylon textile material (mm/min)

| | Target | Ex. 1 | Ex. 2 | Ex. 3 | Ex. 4 | Ex. 5 | Ex. 6 |
|---|---|---|---|---|---|---|---|
| Warp average | <80 | 60 | 31 | 45 | 32 | 52 | 42 |
| Weft average | <80 | 48 | 40 | 47 | 38 | 53 | 35 |

It can be seen that using a blend of hydromagnesite and huntite as the filler in combination with a silicone resin gave a significant improvement with respect to flammability.

TABLE 5a
Edgecomb Resistance in accordance with ASTM D6479
with respect to coatings made using Comparatives
C. 1 to 6 on 470 dtex Nylon textile material (N)

| | Target | C. 1 | C.2 | C. 3 | C. 4 | C. 5 | C. 6 |
|---|---|---|---|---|---|---|---|
| Warp average | >450 | 412 | 475 | 510 | 679 | 609 | 781 |
| Weft average | >450 | 424 | 424 | 491 | 640 | 512 | 673 |

TABLE 5b
Edgecomb Resistance in accordance with ASTM D6479
with respect to coatings made using Ex. 1 to
6 on 470 dtex Nylon textile material (N)

| | Target | Ex. 1 | Ex. 2 | Ex. 3 | Ex. 4 | Ex. 5 | Ex. 6 |
|---|---|---|---|---|---|---|---|
| Warp average | >450 | 484 | 613 | 526 | 582 | 568 | 746 |
| Weft average | >450 | 485 | 572 | 452 | 556 | 525 | 700 |

It can be seen that when comparing the working examples with C1, C2 and C3 without added fillers the examples show a clear improvement in edgecomb resistance. However, of equal if not more importance when comparing the examples herein with C4, C5 and C6, which are filled with fumed silica (C. 4) and calcium carbonate (C5 &6), it can be seen that the examples maintain a similar edgcomb resistance with C4, C.5 and C.6.

TABLE 6a
Flex Abrasion in accordance with ISO5981 with respect
to coatings made using Comparatives. 1 to 6 on
470 dtex Nylon textile material (strokes)

| | Target | C.1 | C. 2 | C. 3 | C. 4 | C. 5 | C. 6 |
|---|---|---|---|---|---|---|---|
| Warp | >600 | Pass | Pass | Pass | Pass | Pass | Pass |
| Weft | >600 | Pass | Pass | Pass | Pass | Pass | Pass |

TABLE 6b
Flex Abrasion in accordance with ISO5981 with respect to coatings
made using Ex. 1 to 6 on 470 dtex Nylon textile material (strokes)

| | Target | Ex. 1 | Ex. 2 | Ex. 3 | Ex. 4 | Ex. 5 | Ex. 6 |
|---|---|---|---|---|---|---|---|
| Warp | >600 | Pass | Pass | Pass | Pass | Pass | Pass |
| Weft | >600 | Pass | Pass | Pass | Pass | Pass | Pass |

It can be seen that the use of a blend of hydromagnesite and huntite as filler replacing silica and/or calcium carbonate gave analogous flex abrasion results.

Hence, it can be appreciated that the hydrosilylation curable silicone coating composition described herein containing silicone resins e.g., MQ resin and a blend of hydromagnesite and huntite as the filler shows good flowability without shear thinning effect and coated textile materials using coatings made from said composition gave maintain their edgecomb resistance maintained adhesion and mechanical strength and as such can be used for coating cut-and-sewn, seam-sealed (CSSS) airbag textiles or to a one-piece woven (OPW) airbags for use as frontal airbags and/or front-centre airbags, designed to act as a cushion at a point of impact especially in collisions with the front or back of the vehicle, i.e. frontal or rear collisions. As previously indicated it is also suitable coatings for textile materials such as for screen printing, as a base coating for silicone leather, as a binder layer coating between a textile and a silicone coating.

1. A hydrosilylation curable silicone coating composition comprising:
(a) an organopolysiloxane polymer having a viscosity of between 100 and 200,000 mPa·s at 25° C., and at least two unsaturated groups per molecule, which unsaturated groups are selected from alkenyl groups or alkynyl groups;
(b) a filler blend of hydromagnesite, and huntite, which filler blend may be treated with a hydrophobing agent;
(c) an organosilicon compound having at least two, optionally at least three, Si—H groups per molecule;
(d) a hydrosilylation cure catalyst;
(e) one or more silicone resins containing unsaturated groups selected from alkenyl groups, alkynyl groups, or a mixture of alkenyl groups and alkynyl groups, selected from T silicone resins, DT silicone resins, MQ silicone resins, MDT silicone resins, MTQ silicone resins, QDT silicone resins, or mixtures thereof; and
(f) an adhesion promoter selected from one or more monoacrylates, diacrylates, or methacrylates; epoxy-containing alkoxysilanes, vinyl-containing alkoxysilanes, alkoxysilanes containing methacrylic groups, or alkoxysilanes containing acrylic groups, and a mixture, a reaction product, or a mixture and reaction product of
i) one or more alkoxysilanes having an epoxy group in the molecule;
ii) a linear organopolysiloxane oligomer containing at least one alkenyl group and at least one hydroxy or alkoxy group per molecule; and
iii) an organometallic condensation reaction catalyst comprising organotitanium, organoaluminum, or organozirconium compounds; or a mixture thereof.

2. The hydrosilylation curable silicone coating composition in accordance with claim 1, wherein component (e) comprises i): one or more MQ silicone resins containing unsaturated groups selected from alkenyl groups, alkynyl groups, or a mixture of alkenyl groups and alkynyl groups; ii) one or more T silicone resins containing unsaturated groups selected from alkenyl groups, alkynyl groups, or a mixture of alkenyl groups and alkynyl groups; or iii) both i) and ii).

3. The hydrosilylation curable silicone coating composition in accordance with claim 1, wherein component (e) is one or more MQ silicone resins containing unsaturated groups selected from alkenyl groups, alkynyl groups, or a mixture of alkenyl groups and alkynyl groups.

4. The hydrosilylation curable silicone coating composition in accordance with claim 1, wherein component (e) is provided in a mixture with some or all of component (a).

5. The hydrosilylation curable silicone coating composition in accordance with claim 1, wherein component (b): i) is hydrophobically treated; ii) is present in the composition in an amount of from 5.0 wt. % to 40 wt. % of the composition; or iii) both i) and ii).

6. A textile material or airbag at least partially coated with a silicone coating which is the cured elastomeric product of the hydrosilylation curable silicone coating composition in accordance with claim 1.

7. The textile material or airbag in accordance with claim 6, wherein the average coating dry weight is from 10 g/m² to 50 g/m² determined in accordance with ISO 3801.

8. The coated textile material or coated airbag in accordance with claim 6, wherein the textile material or airbag is made of polyamide or polyester.

9. The coated textile material or coated airbag in accordance with claim 6, wherein the textile material or airbag is a cut-and-sewn, seam-sealed airbag or a one-piece woven airbag.

10. A method of coating a textile material or airbag, the method comprising:
mixing the components of the hydrosilylation curable silicone coating composition in accordance with claim 1;
coating the textile material or airbag with the composition; and
heating the composition at a temperature of from 150 to 200° C. for up to 5 minutes to cure the coated composition.

11. A coated textile material or coated airbag obtained or obtainable by the method in accordance with claim 10.

12. The coated textile material or coated airbag in accordance with claim 11, wherein the average coating dry weight is from 10 g/m² to 50 g/m² determined in accordance with ISO 3801.

13. The A-coated textile material or coated airbag in accordance with claim 11, wherein the textile material or airbag is made of polyamide or polyester.

14. The coated textile material or coated airbag in accordance with claim 11, wherein the textile material or airbag is a cut-and-sewn, seam-sealed airbag or a one-piece woven airbag.

15. (canceled)
